(19) United States
(12) Patent Application Publication
(10) Pub. No.: US 2014/0272029 A1
(43) Pub. Date: Sep. 18, 2014

(54) Method for Optimizing an Automated Buttering Process

(71) Applicants: Bernhard Heymann, Boenen (DE); Dieter Krohn, Beckum (DE)

(72) Inventors: Bernhard Heymann, Boenen (DE); Dieter Krohn, Beckum (DE)

(73) Assignee: GEA Mechanical Equipment GmbH, Oelde (DE)

(21) Appl. No.: 14/354,699

(22) PCT Filed: Sep. 4, 2012
(86) PCT No.: PCT/EP2012/067179

§ 371 Date: Apr. 28, 2014

(30) Foreign Application Priority Data
Oct. 29, 2011 (DE) 10 2011 117 195.2

(51) Int. Cl. A23C 15/06

(52) U.S. Cl. CPC A23C 15/06
USPC 426/231

(57) ABSTRACT

A method for producing butter employs a buttering machine having an inlet, a buttering cylinder with a beater operated with a drive power by a beater drive, and an outlet. Supplied cream is separated into butter grains and buttermilk in the buttering cylinder. The method involves measuring or predefining a characteristic value of the cream or the produced butter, detecting an actual value of the current drive power of the beater, determining a setpoint value for the drive power of the beater as a function of the characteristic value, and adjusting the beater drive to this setpoint value.

### BACKGROUND AND SUMMARY OF THE INVENTION

Exemplary embodiments of the invention are related to a churning method for an automated buttering process.

In the field of industrial churning methods, the continuous churning has been carried out with a machine according to Dr. Fritz since 1941. A good and uniform quality of butter with minimum fat losses has been ensured by this machine and the corresponding method.

Due to the Fritz-Eisenreich method, the working steps of forming whipped cream, the subsequent formation of butter grains, of separating off buttermilk, and of kneading the butter have been able to be automated in a continuous process. This has ensured the processes of forming butter grains by churning cylinders and the kneading of the butter mass by texturizers with motorized worm drives.

To date, a refinement of the automation process has possible only to a limited extent, since the refinement depends on many factors that are predominantly determined by the cream as the starting material and by the processing of the cream. In addition to the starting properties of the cream, for example fat content and preceding maturation of the cream, process parameters, such as the temperature of the cream, the supply power and the rotational speed of the beater are important characteristic variables for the churning process.

A high fat content results in more rapid formation of butter, since the possibility of fat balls colliding with one another is increased. In addition, fat-rich cream is characterized by high viscosity, which increases even further over the course of beating through the formation of a suspension with air. The consequence is an increased energy requirement during beating. Furthermore, the high viscosity may result in the cream remaining stuck to the cylinder wall, which makes it more difficult to form butter grains.

A further important process parameter is the maturation profile, since the degree of crystallization is dependent on the time and temperature profile. The ratio of liquid fat to crystallized fat has a great influence on the reversal of emulsion in the churning cylinder. At a given rotational speed of the beater, the basic water content of the butter in the case of slowly matured cream having a higher degree of crystallization is lower than in the case of rapidly matured cream.

The pH also has an important influence, since sour cream is more easily churned than cream which is not sour, since the fat balls repel one another less.

The size distribution of the fat balls also plays a role, since smaller fat balls are substantially more stable than larger ones. The churning time therefore increases in the event of predominantly very small fat balls and the process becomes more inefficient.

Due to the constantly changing properties of the cream, the processing to date has been manually monitored and, when the need arises, readjusted by changing the process parameters. A continuous visual checking of the properties, and also experimental values and fingertip feel have been necessary in order to undertake an adjustment. Over-churning is produced by an excessive rotational speed of the beater and is manifested by large clumps of butter and a high water content. Under-churning is produced by too low a rotational speed of the beater and is manifested by a soft mass. While overchurning can be corrected, under-churning results in derailing of the process.

Visual inspection has taken place to date via a viewing glass or a camera and has required the continuous occupation of a staff member in order to check the churning process.

A low basic water content, for the optimum metering in of flavorings, has been achieved here by low rotational speeds of the beater lying only just above under-churning, and has to date made precise manual adjustment necessary irrespective of the remaining automated process steps.

The rotational speed of the beater in the first churning cylinder is therefore a particularly important parameter for the possibility of adjusting the process. The rotational speed is increased as the fat content of the cream decreases, as the pH of the cream rises, as the churning temperature drops and in the event of a greater amount of cream being supplied, and therefore constitutes the decisive adjustment variable with which the influences of all of the other parameters can be compensated for in order to obtain butter of high quality.

Therefore, the rotational speed of the beater has conventionally been adjusted by a frequency-regulated drive with predetermination of a constant adjustment value signal, wherein the drive has taken place, for example, by means of a motor with an alternating voltage of a predetermined constant frequency. Further characteristic variables, such as, for example, the temperature of the cream have had to be kept constant here by a measuring and control unit.

The procedure in the case of the known manual operation corresponds to the customary construction of a control circuit. The result of the process—in this case, the quality of the butter—is assessed and a process variable—in this case the rotational speed of the beater—is increased or lowered in accordance with the deviation from the setpoint state. Since the reaction time from a change in the rotational speed of the beater to the change in quality at the output of the machine may take several minutes, changes to the process parameters can be undertaken only very slowly and carefully.

The temperature of the cream constitutes a further important parameter. A higher temperature results in more rapid formation of butter. Generally, a range of between 11 and 13° C. is selected as the churning temperature because the portions of the solid and liquid phase of the milk fat are then approximately equal.

In addition, the volumetric flow of the supplied cream is of importance. A high volumetric flow indicates a short residence period in the churning cylinder. Every residence period in the churning cylinder has to be reacted to by a correction of the rotational speed of the beater if butter having consistent quality is to be produced.

An optimum churning process is therefore produced from the combination of parameters influencing one another.

One approach to automatic adjustment of the process involves measuring properties of the finished butter, such as, for example, the water content and then adjusting the rotational speed of the beater. Such a procedure is disclosed, for example, by patent documents DD231476, WO8101788 or DD221626A1. A common feature of all of these concepts is that a process variable is adjusted retrospectively according to the process result. The long idle period of a churning machine means that all of these concepts are not suitable for reacting sufficiently rapidly to a rapid change in the process parameters—such as an abrupt change in the supply of cream. Therefore, no such adjustment has been established in practice.

It is known from German patent document DE 10 2009 039272 A to use the current consumption of the texturizer or of the after-churning drum for the adjustment. This leads to good results in respect of reducing a tendency to clog.

Exemplary embodiments of the present invention are directed to a method for producing butter, in which the abovementioned problems occur merely to a reduced extent, if at all. In particular, a method in which a constant butter quality is ensured even if the volumetric flow of the supplied cream and the temperature of the cream change.

A method for producing butter in a churning machine having at least one inlet, a churning cylinder with a rotatable beater, which is operated with a driving power via a beater drive, and an outlet, and in which supplied cream is converted into butter grains and buttermilk in the churning cylinder, has at least the following steps:
a. predetermining or measuring at least one characteristic value of the cream,
b. detecting an actual value of the current driving power of the beater, and
c. determining a setpoint value of the driving power of the beater depending on the characteristic value measured or predetermined in step a. and adjusting the beater drive to the setpoint value.

In contrast to the previously known approach of automatic adjustment, the present invention is based on the finding that the driving power, which is required for optimum quality of the butter, of the beater shaft can be precalculated from different input parameters, such as fat content of the cream, inlet temperature and/or supply quantity. The substantial advantage of this type of adjustment is that, in the event of a change in the process conditions, such as, for example, a change of tank or a change in power, the beater power can be adapted in an anticipatory manner and there is not only a reaction whenever a change in quality has occurred. The rapidity of the adjustment is also not limited by an idle period, as in the previously described case.

Such an adjustment of a churning machine is permitted by a very substantially unsupervised operation of the machine, provides automatic adaptation to varying process conditions, and achieves a very constant butter quality. It also provides improved possibilities of optimizing the process settings within the context of a low basic water content in the butter, as a result of which taste-providing bacteria cultures can be metered in in accordance with the Nizo method, as can also salt paste and drinking water (up to a maximum water content of 16% in the finished butter).

In addition to relieving the operating staff of work, the risk of failure periods due to process malfunctions is also drastically reduced. Furthermore, the automatic adjustment affords the possibility of adapting the system power in a simple manner to removal in the downstream packaging line. The automatic contents adjustment of a butter silo connected in between is thereby also possible.

The adjustment according to the invention of the churning process avoids the risk of under-churning and makes it possible simultaneously to incorporate a plurality of characteristic variables of the cream and also corresponding process variables into the adjustment of the driving power. In addition, various effects and characteristic variables partially compensate for one another and therefore an energy saving in comparison to previous methods is achieved.

In a preferred embodiment, the driving power can be adjusted as a function of the fat content of the cream, the temperature of the cream or the quantity of the cream as cream characteristic variables as characteristic values. It is therefore ensured that there does not have to be any additional control for keeping the temperature of the cream constant or for manually monitoring the metered quantity of cream; instead, all of these variables are incorporated into the evaluation for adjusting an optimum driving power. In addition to a more precise coordination of the churning process, a simplification of the apparatus can also be undertaken as a result, by omitting the temperature checking unit for the cream.

Particularly preferred in this connection is a method that directly permits these characteristic variables by a multi-dimensional adjustment of the driving power, as a result of which a multiplicity of properties of the cream are used in order to adjust the driving power of the beater.

This takes place if each individual parameter can be computer-monitored by means of characteristic fields in order to achieve a consistently high-value churning result. Each characteristic variable of the cream can therefore also be evaluated specifically in characteristic fields, as a result of which, in addition to the precise individual monitoring, checking of the quality of the cream is also simplified.

During the churning, the temperature of the cream plays a decisive role in the separation into butter grains and buttermilk.

The method therefore preferably ensures by means of adjustment that the cream is heated to a maximum of not more than 10 Kelvin, preferably not more than 3 Kelvin.

The driving power of the beater can advantageously be determined by a simple measuring structure, by means of a frequency converter.

In an advantageous embodiment of the invention, the butter grains are cooled by a cooling section. The cooling takes place between the churning and an after-churning in order to provide the respective butter grains with harder consistency and to permit easier setting of the optimum butter grain size in the after-churning process.

In the after-churning process, the butter grain size is controlled in an after-churning drum in order to subsequently form a homogeneous mass in the texturizer and to avoid fat concentrations or water voids.

The butter grains are transferred from the after-churning process, with the buttermilk being conducted away, into a texturizer which, with the aid of a worm drive, kneads the butter grains, frees the latter from buttermilk residues and homogenizes the butter grains in respect of the distribution of water.

In addition, following the separating of the cream into butter grains and buttermilk, a mixing in of additives by a further texturizer is sought. Taste and appearance of the product can be varied in this step. The additives required for this can be incorporated relatively easily into the butter as a result of the homogenization.

In addition, in an advantageous variant of the method, air voids are sucked off from the product in a vacuum zone in order thereby to improve the durability of the butter.

In order to carry out a subsequent precise adjustment of the consistency and also of the water content in the butter, a further texturizer and a mixing zone for metering water are advantageously provided in the machine following the vacuum zone.

The finished butter can then be removed from the apparatus by an ejector pump.

The optical check, by means of an inspection window in the wall of the after-churning drum, affords the advantage of a further monitoring possibility, in addition to the possibility of monitoring cream-specific variables.

In an advantageous embodiment of the invention, a measuring and control unit, coupled to the beater drive, monitors the current driving power of the beater and compares the driving power with the variable characteristic variables of the fat content of the cream, the temperature of the cream and the supply of cream, in order subsequently to adapt the driving power of the beater to a predetermined setpoint value. The sensor arrangement therefore permits an uncomplicated and, in addition, time-relevant monitoring of the production process. The setpoint value here can be defined, for example, optically, by viewing the churning process through the inspection window.

In order to simplify the adjustment operation, all of the characteristic variables are entered into a calculating value (BCU value) in which contrasting effects, for example of the temperature and the quantity of the cream, are at least partially compensated for and the setpoint value is adapted to said calculation value by adjustment of one or more characteristic variables.

### BRIEF DESCRIPTION OF THE DRAWING FIGURES

An exemplary embodiment of the invention is explained with reference to the attached drawings; furthermore, drawings, with reference to which the solution to the problem is illustrated, are listed. In the drawings:

FIG. 1 shows a schematic illustration of a churning machine which is operated according to the Fritz-Eisenreich method,

FIGS. 2a-c show a sequence of drawings of the process of churning, over-churning and under-churning,

FIG. 3 shows a schematic diagram of various characteristic variables and the influence thereof on the required driving power of a beater of a churning cylinder,

FIGS. 4a-c show various characteristic fields for the adjustment of the power of a churning machine,

FIG. 5 shows a measured value table of the automatic adjustment of the driving power of the beater after a cream supply period by means of a BCU calculation value, and

FIGS. 6a-d show diagrams which illustrate the results of manual or automatic adjustments.

### DETAILED DESCRIPTION

FIG. 1 shows a churning machine which has an inlet 1 for cream, and also a churning cylinder 2 with a rotatably driven beater 3 for forming butter grains and buttermilk from the supplied cream.

In a cooling section 4, the butter grains obtain a harder consistency and can subsequently be better processed.

In an after-churning drum 5, the optimum butter grain size is set in the after-churning process.

A texturizer 6 reduces the content of butter in buttermilk residues that are subsequently removed.

In a mixing zone 7, water, acid concentrate and brine are metered into the butter in order to optimize the taste and the consistency of the butter.

In a vacuum chamber 8, air is removed from the butter in order to increase the durability thereof.

A further texturizer 9, together with a following mixing zone 10, ensures a uniform distribution of the water content in the butter and an optimization of the water content.

The discharging of the finished butter from the machine is ensured by an ejector pump 11.

The beater 3 is driven by the beater drive 12 which, in turn, is connected to the measuring and control unit 15.

An optical check of the after-churning process can additionally take place through an inspection window 14.

FIG. 2 illustrates an optimum churning process (FIG. 2a) and also over-churning (FIG. 2c) and under-churning (FIG. 2b) from the inspection window perspective 14. The mechanical work performed by the beater 3 in the churning cylinder 2 largely determines the grain size of the butter grains here. In the optimum case, said butter grains are fist-sized.

The driving power of the beater, which is operated by the beater drive 12, is provided in FIG. 3 as a function of characteristic variables, such as the fat content of the cream, the duration of the maturation of the cream, the temperature of the maturation of the cream, the temperature of the cream and the supply power of the cream. The determined setpoint value of the measuring and control system 15 adjusts the driving power that has to be applied by the beater drive 12 in order to equalize the rotational speed of the beater to a corresponding setpoint value.

FIG. 4 shows various characteristic fields that illustrate and permit
a) an adjustment of the power on the basis of the percentage content of the cream,
b) an adjustment of the power according to the temperature of the cream, and
c) an adjustment of the power according to the quantity of cream.

The evaluation and summarizing of a plurality of characteristic variables to form a calculation value (BCU—churning units) permits the particularly specific adjustment of the power of the beater.

It is thus assumed according to a preferred model that the required energy for churning a mass unit is constant at a given temperature. With this assumption, inflow quantity changes can simply be reacted to in an automatically adjusting manner by a corresponding change in power.

For example, the influence of a change in temperature per mass unit can furthermore be determined by measuring series. The values are stored or, for example, are summarized in a formula. Then, by making recourse to the characteristic fields, the power of the beater can also automatically be adapted as a function of the temperature.

FIG. 5 shows a characteristic field of the summarized calculation value BCU for monitoring and for the checking of the process, on the basis of which the driving power of the beater 3 of the churning cylinder 2 after the supply of cream is adjusted. In this variant embodiment, the BCU calculation includes, for example, the supply power or the quantity of supply, the density of the cream and the driving power output. This provides the possibility of reacting directly, for example, to a variable fat content of the cream.

In a series of tests in an installation having a churning machine BUE 6000 from Westfalia Separator, the adjustment according to the invention was compared with the previous manual correction during continuous commercial production. The temperature of the cream and quantity of the cream were varied here within very wide ranges, which is normally avoided in normal production (see FIG. 6a-d). The basic water content was recorded for a period (x axis) as a measure of the degree of churning (y axis).

FIG. 6a shows results of a manual correction of the rotational speed of the beater in the event of a change in the supply quantity, as has previously taken place.

FIG. 6b shows the advantageous results of an automatic adjustment of the power of the beater as a function of a change in the supply quantity;

FIG. 6c shows results of a manual correction of the rotational speed of the beater in the event of a change in the temperature of the cream; and

FIG. 6d shows the advantageous results for an automatic adjustment of the power of the beater as a function of a change in the temperature of the cream.

In a comparison of FIGS. 6a and 6b or FIGS. 6c and 6d, it can be determined that the results of the automatic adjustment are absolutely equal to the manual setting.

If the churning process is adapted manually to each change in the power of the cream (supply quantity), then, during each setting, a certain time elapses until the desired degree of churning is found again. In the case of the incremental setting of the rotational speed, over-churning or under-churning therefore occurs within certain time intervals, this being expressed by local minima and maxima in the basic water content of the butter. By contrast, in the adjusted operation, the machine operator merely sets the desired supply quantity, after which the power of the beater is directly adapted. As a result, even in the event of a changed quantity of cream, the churning can take place more uniformly.

Whereas a change in the power of the cream can take place very rapidly, a change in the temperature of the cream takes place more slowly and also in a fluctuating manner. An adaptation of the power of the beater here is therefore more difficult to bring about. However, it was also possible to demonstrate here that, in the adjusted process, the power of the beater can be adapted, even in the event of changes in temperature, in such a manner that reliable process management is made possible.

All in all, the churning process can be implemented more simply and reliably by the invention, since unintentional fluctuations in temperature and changed quantities of cream can be absorbed by adapting the power of the beater. The churning process remains reliably controllable even in the event of relatively large fluctuations. In comparison to a manual process management, it was not possible to determine any substantial difference in the process or product quality.

In order to improve the process even further, it is conceivable to install a camera in the second churning cylinder. Transmitting the photographs taken by the camera to a control room provides the possibility of checking the churning machine from another room and of undertaking changes to the process from there.

A further optimization of the process can be achieved by the inlet of cream being adjusted via the filling level of the butter silo. For this purpose, it is expedient to equip the butter silo with weighing cells that continuously measure the weight of the container and forward the weight to the controller. If a predetermined threshold value of the filling level is exceeded, the flow of cream is reduced. If a threshold value is fallen short of, the quantity of cream is increased. The level of the quantity of cream to be churned can therefore be determined via the checking of the filling level of the butter silo.

In a development of the invention, provision can be made to incorporate different fat contents, fatty acid spectra and maturation profiles of the cream and correspondingly to adapt the power of the beater in respect of these parameters.

In particular, an adaptation of the power can take place in the event of a change of tank with new cream, since such a change is always accompanied by a change in the temperature and the fat content.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Reference Numbers

Inlet 1
Churning cylinder 2
Beater 3
Cooling section 4
After-churning drum 5
Texturizer 6
Mixing zone 7
Vacuum chamber 8
Texturizer 9
Mixing zone 10
Ejector pump 11
Beater drive 12
Drive 13
Inspection window 14
Measuring and control unit 15

1-25. (canceled)

26. A method for producing butter in a churning machine having at least one inlet, a churning cylinder with a rotatable beater operated with a driving power via a beater drive, and an outlet, wherein supplied cream is converted in the churning cylinder into butter grains and buttermilk, the method comprising:
a. measuring or predetermining a characteristic value of the cream;
b. detecting, by a measurement and control unit, an actual value of a current driving power of the rotatable beater; and
c. determining, by the measurement and control unit, a setpoint value of the driving power of the beater as a function of the characteristic value of the cream and adjusting the beater drive to the setpoint value.

27. The method of claim 26, wherein the characteristic value of cream is an added quantity of cream.

28. The method of claim 26, wherein the characteristic value of cream is a temperature of the cream.

29. The method of claim 26, wherein the characteristic value of cream is a fat content of the cream.

30. The method of claim 26, further comprising:
additionally adjusting the driving power of the beater a function of a water content of the butter.

31. The method of claim 26, wherein the driving power of the beater is controlled based on a multi-dimensional adjustment using a plurality of characteristic values and a water content of the butter.

32. The method of claim 26, further comprising:
visually depicting individual characteristic variables and modification of the individual characteristic variables during the churning process.

33. The method as claimed in claim 26, wherein the cream is heated during the churning process to a maximum of 10 K.

34. The method of claim 26, further comprising:
detecting the current driving power of the beater using frequency converters.

35. The method of claim 26, wherein the butter grains are cooled between step a and step b by a cooling section.

36. The method of claim 26, wherein an optimization of the a size of the butter grain occurs in an after-churning drum.

37. The method of claim 36, wherein the butter grains are processed in a texturizer downstream of the after-churning drum.

38. The method of claim 37, wherein additives are metered in and mixed by a mixing zone following the texturizer.

39. The method of claim 38, wherein air is removed from a butter mass by a vacuum zone following a mixing zone.

40. The method of claim 39, wherein precise adjustment of consistency of the butter and also of the water content of the butter is performed using a further texturizer and a further mixing zone following the vacuum zone.

41. The method of claim 26, wherein finished butter mass is discharged by an ejector pump following a mixing zone.

42. The method of claim 26, wherein additional optical checking of the churning process in the after-churning drum takes place via inspection windows.

43. The method of claim 26, wherein, in order to monitor and control the churning, a calculation value is calculated from various product and process characteristic variables, the calculation value, in conjunction with the measuring and control unit, to adapt the churning process to a predetermined setpoint value.

44. The method of claim 43, wherein the calculation value is calculated by including characteristic variables including a quantity of cream, a temperature of the cream, and fat content of the cream, and the calculation value is set to the predetermined setpoint value by adjusting the characteristic variables.

45. The method of claim 26, wherein a camera is provided in the churning cylinder, and images taken by the camera are transmitted into a control room.

46. The method of claim 26, wherein the churning process is monitored from a control room.

47. The method of claim 26, wherein a supply of cream is adjusted via a filling level of a butter silo.

48. The method of claim 47, wherein the butter silo is equipped with weighing cells that continuously measure a weight of the butter silo and forward the weight to the measurement and control unit.

49. The method of claim 26, wherein adjustment of the driving power of the beater accounts for different fat contents, fatty acid spectra, and maturation profiles of the cream.

50. The method of claim 26, wherein the driving power of the beater is adjusted when new cream is provided to the churning cylinder.
